(19) United States
(12) Patent Application Publication
(10) Pub. No.: US 2021/0047765 A1
(43) Pub. Date: Feb. 18, 2021

(54) PROCESS FOR TREATING OF THREADS

(71) Applicant: TWINE SOLUTIONS LTD., Petah Tikva (IL)

(72) Inventors: Ilanit MOR, Kiryat Ono (IL); Alon MOSHE, Petach Tiqva (IL); Ana Lea DOTAN, Ramat Gan (IL); Dan LEWITUS, Herzliya (IL); Yael ROTH, Tel Aviv (IL); Gilad GOTESMAN, Netanya (IL); Noam SIDELMAN, Tel Aviv (IL)

(21) Appl. No.: 16/769,029

(22) PCT Filed: Dec. 2, 2018
(86) PCT No.: PCT/IL2018/051320

§ 371 Date: Jun. 2, 2020

(30) Foreign Application Priority Data
Dec. 3, 2017 (IL) 256062

(51) Int. Cl. D06B 9/02; D06M 15/59; D06M 15/507; D06P 5/20; D06P 3/52; D06P 3/24; D06P 1/44; D06P 5/00

(52) U.S. Cl. CPC D06B 9/02; D06M 15/59; D06M 15/507; D06P 5/2066; D06Q 1/04; D06P 3/24; D06P 1/445; D06P 5/002; D06P 3/52

(57) ABSTRACT

The present invention provides a rapid and highly efficient process for treating textile threads, especially dyeing, and treated threads obtained thereby of textile threads.

### TECHNICAL FIELD

The present invention provides a rapid and highly efficient process for treating of textile threads, and further relates to treated threads obtained by the process. More specifically, the present invention provides a rapid and highly efficient process for dyeing of textile threads.

### SUMMARY OF INVENTION

In one aspect, the present invention provides a process for treating of a textile thread, the process comprising: (i) treating the thread with a swelling agent or a solution comprising it, thereby swelling the thread thus enhancing penetration of treatment molecules into amorphous regions of the thread at a temperature higher than the glass transition temperature (T_{g}) or modified T_{g} of the thread; (ii) treating the thread; and (iii) optionally treating the thread with a binder or a coating material capable of: fixing treatment molecules left thereon to the surface of the thread; further treating; dyeing; matt-glossing; glittering; and/or add a metallic look and/or adding functionality such as conductivity, bioactivity, or any other functional smart textile capability, etc.

In another aspect, the present invention relates to a treated textile thread obtained by the process defined above.

### BRIEF DESCRIPTION OF THE FIGURES

Embodiments, features, and aspects of the invention are described and illustrated herein with reference to the accompanying drawings in which:

FIG. 1 is a picture of an optical microscope capture of the cross section fibers dyed according to the process of the invention.

FIG. 2 is a picture of an optical microscope capture of the cross section of fibers dyed according to the process of the invention.

FIGS. 3A-3F are pictures of 6 identical threads, each coated with a different material, and a stained fabric which was rubbed against the coated threads.

### DETAILED DESCRIPTION OF THE INVENTION

Twine's proprietary technology will enable the creation of user defined treated thread on-demand and on-machine, providing significant value to both existing and new businesses and consumer sewing, knitting, embroidery and any thread-consuming markets and revolutionizing the way those systems work, replacing the need to identify, find and use pre-treated threads.

For achieving the above, there is a need to treat the thread at the rate of the thread-consuming machines being used. This means treating the thread (and drying thereof) roughly at a speed of 0.01-10 m/sec. Such rates are much faster than conventional treating processes which usually take few hours. Furthermore, treating processes usually use vast amount of water and hazardous chemicals which creates ecological problems. Those chemicals are used for pre-treatment, treating and post treatment of the treated thread/fabric. Accordingly, the present invention provides a device, system and method that are capable of treating a thread passing through at a speed of from about 0.01 to about 10 m/sec; from about 0.01 to about 9 m/sec; from about 0.01 to about 8 m/sec; from about 0.01 to about 7 m/sec; from about 0.01 to about 6 m/sec; from about 0.01 to about 5 m/sec; from about 0.01 to about 4 m/sec; from about 0.01 to about 3 m/sec; from about 0.01 to about 2 m/sec; from about 0.05 to about 10 m/sec; from about 0.1 to about 10 m/sec; from about 0.2 to about 10 m/sec; from about 0.3 to about 10 m/sec; from about 0.5 to about 10 m/sec; from about 1 to about 10 m/sec; from about 2 to about 10 m/sec; from about 3 to about 10 m/sec; from about 4 to about 10 m/sec; from about 5 to about 10 m/sec; or about 10 m/sec or more.

The present invention provides a process for treating of a textile thread, wherein the thread is first pretreated with a swelling agent that enables treatment-material buildup on the fibers surface and enhances penetration of treatment molecules into amorphous regions of the thread at a temperature higher than the glass transition temperature (T_{g}) or modified T_{g} of the thread; treated; and then optionally further treated with a binder or a coating material capable of: fixing treatment-molecules excess to the surface of the thread, if left thereon; dyeing; matt-glossing; glittering; fluorescent; phosphorescent and/or add a metallic look or adding functionality such as conductivity, bioactivity, or any functional smart textile capability. The process disclosed herein is very rapid (about a few seconds to a few minutes) relatively to the treating processes known in the art and currently available, mainly due to the pretreatment step, in which the thread is treated with a particular swelling agent or with a solution containing same; and may even be shorten by dissolving the treatment molecules in the swelling agent or in the solution, i.e., by simultaneously carrying out the pretreatment step with the treating step. In sharp contrast to the treating methods currently available, the process disclosed herein does not include chemical clearing of excess treating agent (e.g. pigment or dye), and further does not require any washing stage (either prior or post treating).

In certain embodiments, the treating process of the present invention includes the following steps: swelling of the thread, wetting the thread with the treating solution to enable treating-molecules build-up on the surface of the (swollen) thread fibers, and then diffusion of the treating-molecules into the fibers and finally evaporation of the solvent/s and collecting the vapors by a condensing process. In specific embodiments, a step of squeezing the thread, or sonicating or other mechanical process or using wetting agents in the formulation, is applied in order to enhance the wetting thereof and further improve treating-molecules build-up on the surface of the thread fibers.

In one aspect, the present invention thus provides a process for treating of a textile thread, the process comprising: (i) treating the thread with a swelling agent or a solution comprising it, thereby swelling the thread thus enhancing penetration of treating-molecules into amorphous regions of the thread at a temperature higher than the glass transition temperature (T_{g}) or modified T_{g} of the thread; (ii) treating the thread; and (iii) optionally treating the thread with a binder or a coating material capable of: fixing the treating- molecules left thereon to the surface of the thread; dyeing; matt-glossing; glittering; and/or add a metallic look, and/or adding functionality such as conductivity, bioactivity, or any functional smart textile capability.

In one particular such aspect, the invention provides a treating process comprising: (i) treating the thread with a swelling agent or a solution comprising it, thereby swelling the thread thus enhancing penetration of treating-molecules into amorphous regions of the thread at a temperature higher than the glass T_{g} or modified T_{g} of the thread; and (ii) treating the thread. In another particular such aspect, the invention provides a process comprising: (i) treating the thread with a swelling agent or a solution comprising it, thereby swelling the thread thus enhancing penetration of treating-molecules into amorphous regions of the thread at a temperature higher than the glass T_{g} or modified T_{g} of the thread; (ii) treating the thread; and (iii) further treating the thread with a binder or a coating material capable of: fixing treating-molecules left thereon to the surface of the thread; dyeing; matt-glossing; glittering; and/or add a metallic look, and/or adding functionality such as conductivity, bioactivity, or any functional smart textile capability.

In another particular such aspect, the invention provides a process for rapid treating of a textile thread, the process comprising: (i) treating the thread with a swelling agent or a solution comprising it, thereby swelling the thread thus enhancing penetration of treatment-molecules into amorphous regions of the thread at a temperature higher than the glass transition temperature (T_{g}) or modified T_{g} of the thread; (ii) treating the thread by injecting/dispensing thereon predefined, adjusted amount of treatment solution/dispersion, i.e. colorant(s), polymer(s), chemical(s) or drug(s), according to the thread type and characteristics; and (iii) optionally treating the thread with a binder or a coating material capable of: (a) fixing treatment-molecules left thereon to the surface of the thread; (b) adding color to the treated thread; (c) adding matt-glossing look to the treated thread; (d) adding glittering; (e) adding a metallic look to the treated thread; and/or (f) adding functionality such as conductivity, bioactivity, friction, or any other functional smart textile capability, etc. to the treated thread, wherein the treated thread is kept at a desired and controlled tension throughout the entire treating process.

In another particular such aspect, the invention provides a process for rapid treating of a textile thread, the process comprising: (i) treating the thread with a swelling agent or a solution comprising it, thereby swelling the thread thus enhancing penetration of treatment-molecules into amorphous regions of the thread at a temperature higher than the glass transition temperature (T_{g}) or modified T_{g} of the thread; (ii) treating the thread; and (iii) optionally treating the thread with a binder or a coating material capable of: (a) fixing treatment-molecules left thereon to the surface of the thread; (b) adding color to the treated thread; (c) adding matt-glossing look to the treated thread; (d) adding glittering; (e) adding a metallic look to the treated thread; and/or (f) adding functionality such as conductivity, bioactivity, friction, or any other functional smart textile capability to the treated thread.

The term “treating” or “treatment” as used herein means any process of adding material(s) to and/or onto and/or into a thread/fiber for providing thereof added value. Non-limiting examples of such treating are dyeing, polymer dispersion, chemical dispersion, drug dispersion, etc. Accordingly, the term “treating-molecules” as used herein may refer to dye molecules, polymers, chemicals, drugs, etc.

The term glass transition or glass-liquid transition, as used herein, refers to the reversible transition in amorphous materials (or in amorphous regions within semi- crystalline materials) from a hard and relatively brittle state into a molten or rubber-like state. Despite the massive change in the physical properties of a material through its glass transition, the transition is not itself a phase transition of any kind; rather it is a phenomenon extending over a range of temperature and defined by one of several conventions, e.g., a constant cooling rate and a viscosity threshold. Upon cooling or heating through this glass-transition range, the material also exhibits a smooth step in the thermal-expansion coefficient and in the specific heat, with the location of these effects again being dependent on the history of the material. A glass-transition temperature T_{g} is always lower than the melting temperature, Tₘ, of the crystalline state of the material, if one exists. A glass-transition temperature T_{g} might be affected by the presence of a solvent or any other plasticizer, for example, and will be defined as “modified T_{g}”.

The term “functional smart textile capability” include, but is not limited to any of the following capabilities: flame retardant; antistatic and conduciveness radioactive; water repellent; oil repellent; dirt repellent; light reflective; light absorbing; thermo-indicating; thermo-insulating; thermos-conductive; pH-indicating; chemical indicating, magnetic, and any combination thereof.

In certain embodiments, the process of the invention further comprises a heating step. The heating may be heating the thread, wherein the heating of the thread may be: (a) immediately prior to step (i); (b) immediately after step (i) and prior to step (ii); (c) immediately after step (ii) and prior to step (iii); (d) after step (iii); (e) throughout the entire process; (f) throughout steps (i) and/or (ii); and/or (g) throughout steps (ii) and/or (iii).

In other embodiments, the thread is heated to a temperature of from about 30° C. or room temperature to about the melting point of the thread. In other embodiments, the thread is heated to a temperature of from about room temperature to about 80° C.; from about room temperature to about 70° C.; from about room temperature to about 60° C.; from about room temperature to about 50° C.; from about room temperature to about 40° C.; from about 30° C. to about 80° C.; from about 40° C. to about 80° C.; from about 50° C. to about 80° C.; or from about 60° C. to about 80° C.

In alternative or complementary embodiments of the process of the invention, the binder, the swelling agent and/or the coating are, each or any combination thereof, heated to a temperature of from about 30° C. or room temperature to about the melting point of the thread. In other embodiments, the binder, the swelling agent and/or the coating are, each or any combination thereof, heated to a temperature of from about room temperature to about 80° C.; from about room temperature to about 70° C.; from about room temperature to about 60° C.; from about room temperature to about 50° C.; from about room temperature to about 40° C.; from about 30° C. to about 80° C.; from about 40° C. to about 80° C.; from about 50° C. to about 80° C.; or from about 60° C. to about 80° C. In specific embodiments, the binder, the swelling agent and/or the coating are, each or any combination thereof, are heated to a temperature higher than 80° C., such as 100° C., 120° C., 140° C., 160° C., 180° C. and 200° C.

In certain embodiments, the process of the invention further comprises a step of keeping the treated thread at a desired tension throughout the treating process. Such desired tension is determined according to the type of thread, the type of treatment and solvent, the desired outcome-color/color-pattern (in case of dyeing), the speed of treating, etc.

In certain embodiments, the process of the present invention further comprises squeezing of the thread. Such squeezing can be done (a) immediately prior to step (iii); (b) immediately after step (iii); (c) together with the treating step (iii); and/or (d) together with the treating step (ii). Such squeezing can be done either as a pretreatment or as a post treatment of the thread.

In some particular such embodiments, the squeezing step is carried out separately from the treating step, and the process of the present invention thus comprises the steps of: (i) treating the thread with a solution comprising a swelling agent, thereby swelling the thread thus enabling treatment-molecules buildup on the fibers surface and enhancing penetration of treatment-molecules into amorphous regions of the thread at a temperature higher than the T_{g} or modified T_{g} of the thread; (ii) treating the thread; (iii) squeezing the thread; and (iv) optionally further treating the thread with a binder or a coating material capable of: fixing treatment-molecules left thereon to the surface of the thread; dyeing; matt-glossing; glittering; and/or add a metallic look, and/or adding functionality such as conductivity, bioactivity, or any other functional smart textile capability. In other particular such embodiments, the squeezing step is carried out together with the treating step (ii), and the process of the present invention thus comprises the steps of: (i) treating the thread with a solution comprising a swelling agent, thereby swelling the thread thus enabling treatment-molecules buildup on the fibers surface and enhancing penetration of treatment-molecules into amorphous regions of the thread at a temperature higher than the T_{g} or modified T_{g} of the thread; (ii) simultaneously squeezing and treating the thread; and (iii) optionally treating the thread with a binder or a coating material capable of: fixing treatment-molecules left thereon; dyeing; matt-glossing; glittering; and/or add a metallic look, and/or adding functionality such as conductivity, bioactivity, or any other functional smart textile capability.

According to the process of the present invention, the treating step can be carried out utilizing any technology or procedure known in the art. For example, the treating step can be carried out by dipping the thread in a solution comprising the treatment-molecules; dripping the solution on the thread; injecting/dispensing the solution onto the thread; or ink jetting the solution onto the thread. Notably, the term ink jetting can be considered as a specific case of injecting.

In certain embodiments, the process of the present invention is slightly modified so as to shorten the overall time required for completion of the process, such that the pretreatment step (i) and the treating step (ii) are carried out simultaneously. In these embodiments, the treatment-molecules are dissolved in the swelling agent or solution comprising it, and the thread is being treated with the swelling agent and treated at the same step.

In certain embodiments, the process of the present invention as defined in any one of the embodiments above further comprises at least one step of drying the thread being treated. This is for drying the thread and/or for heat-setting for raw threads. The heating may also accelerate the diffusion of the treatment molecules into the thread fibers and for certain materials it also assists in sublimation of excess material from the surface of the thread. In one particular such embodiment, the process comprises the step of drying the thread after the treating step (ii) and prior to treatment with the binder or coating material in step (iii). In another particular such embodiment, the process of the invention comprises the step of drying the treated thread obtained in step (ii) after treatment with the binder or coating material. In a further particular such embodiment, the thread treated is being dried twice, wherein the process of the invention comprises the steps of drying the thread both after the treating step (ii) and prior to treatment with the binder or coating material, as well as after treatment with the binder or coating material.

The term “textile thread” as used herein relates to any type of thread known in the art and used, e.g. in the textile industry, medical use, cosmetics, etc. Textile threads usually consist of multiple yarns, i.e., spun agglomerations of fibers used for knitting, weaving, embroidery or sewing, plied together producing a long, thin strand used in sewing or weaving. The term fiber, as used herein, denotes a single filament of a natural material such as cotton, linen or wool; or an artificial material such as nylon or polyester, measured in terms of linear mass density, i.e., the amount of mass per fiber unit length.

The thread treated according to the process of the present invention may be any textile thread, e.g. as defined above. Alternatively, the thread treated according to the process of the present invention may be any thread for medical use.

In certain embodiments, the thread treated according to the process of the invention either comprises, or consists of, a natural material; in other embodiments, the thread treated according to the process of the invention either comprises, or consists of, a synthetic material; and in further embodiments, the thread treated according to the process of the invention either comprises, or consists of, a semisynthetic material. It should be understood that a thread consisting of a natural, synthetic or semisynthetic material is a thread wherein all the fibers composing the thread are made of a natural, synthetic or semisynthetic material, respectively. In contrast, a thread comprising a natural, synthetic or semisynthetic material is a thread wherein some of the fibers composing the thread are made of a natural, synthetic or semisynthetic material, while other of the fibers composing the thread are made of a different material, e.g., a thread composed of both natural- and synthetic-based fibers, or a thread composed of both synthetic- and semisynthetic-based fibers.

Examples of natural materials include, without being limited to, linen, which is made from the flax plant and composed of about 70% cellulose and about 30% pectin, ash, woody tissue and moisture; wool, which grows from the skin of sheep and composed of protein; silk, which is a fine, continuous strand unwound from the cocoon of a moth caterpillar known as the silkworm, and composed of protein; jute, which is taken from a tall plant of the same name; kapok, which is a white hair-like fiber obtained from the seed capsules of plants and trees called Ceiba Pentandra, and called silk cotton due to its high luster which is equal to that of silk; and ramie, which is a woody fiber resembling flax, also known as rhea and China grass, and taken from a tall flowering plant.

Examples of synthetic materials include, without limiting, cellulose, rayon, more particularly viscose and high wet modulus (HWM) rayon, acetate, tri-acetate, polymer fibers such as polyester, e.g., polyethylene terephthalate (PET) and polybutylene terephthalate (PBT), polyamide, e.g., aliphatic polyamide (nylon) or aromatic polyamide (aramid), spandex (lycra or elastane), and acrylic.

The term “semisynthetic material” as used herein refers to a material with naturally long-chain polymer structure that is only modified and partially degraded by chemical processes, in contrast to completely synthetic fibers such as polyamide or polyester, synthesized from low-molecular weight compounds by polymerization reactions.

According to the present invention, the thread can be treated in step (i) with either a swelling agent or a solution comprising the swelling agent. In other words, while liquid swelling agents can be used in step (i) as is, solid or semi-solid swelling agents, e.g., salts, should be dissolved in a solvent so as to be used. Such solvents may be selected from both inorganic solvent, more specifically water, and organic solvents, and may also be combinations of both inorganic and organic solvents.

Examples of swelling agents include, without being limited to, acetic acid, acetic anhydride, a ketone such as acetone, diethylketone, benzyl acetone, acetophenone, an ester like ethylheptanoate, 4-tert-Butylcyclohexyl acetate, butyl lactate, ammonia, ammonium nitrate, ammonium sulphate, amyl acetate, aniline, aqua regia (a mixture of nitric acid and hydrochloric acid), basic chrome sulphate, benzene, benzyl derivatives such as benzoic acid, benzyl acetate, benzyl alcohol, benzaldehyde, methyl benzoate, ethyl benzoate, propyl benzoate, butyl benzoate, hexyl benzoate, benzyl formate, benzyl propionate, benzyl chloride, benzaldehyde glyceryl acetal, phenethyl derivatives such as, phenethyl alcohol, phenethyl acetate, phenethyl formate, benzyl acetone, phenoxy ethanol, borax (sodium borate, sodium tetraborate, or disodium tetraborate), bromine, butane gas, butanol, butyl acetate, butyric acid, calcium chloride, calcium hydroxide, calcium soap fat, camphour oil, carbon dioxide, carbon disulfide, carbon tetrachloride, caustic soda, chloral hydrate, chlorobenzene, chloroform, chromic acid, citric acid, coal gas, copper sulphate, cyclohexanol, cyclohexanone, dibutyl phthalate, dioctyl phthalate, dinonyl phthalate, diesel oil (diesel fuel), 1,2-dibromoethane, 1,2-dichloroethane, dimethyl formamide, dioxane, ether, ethyl alcohol, ethylene chloride, ethylene glycol, an ethoxylated alcohol, ethyl acetate, ethylene chlorohydrin, an eugenol, diacetone alcohol, ferric chloride, formic acid, furfuryl alcohol, glycerol, a glycol, hydrochloric acid, hydrofluoric acid, hydrogen sulfide, isopropyl alcohol, isopropyl acetate, methyl alcohol, methyl amine, nitric acid, potassium carbonate/cyanide/dichromate, potassium/sodium/ammonium hydroxide, propionic acid, propyl alcohol, sulfuric acid, nitrobenzene, phenol, anisole, 1-Phenoxy-2-propanol, Ethylene glycol phenyl ether methacrylate, m-Cresol, methyl salicylate, triethanolamine, trichloroethylene, and triisopropanolamine. The concentration of the swelling agent in the swelling agent solution may be any suitable concentration, and may vary from, e.g., about 5% or about 10% swelling agent to about 60%, 70%, 80% or more swelling agent in the solution.

In specific embodiments, the treating material is dye. The dye used according to the process of the present invention can be any dye used in the textile industry, as well as combinations of such dyes. Non-limiting examples of such dyes include disperse dyes such as an azobenzene (Azo), e.g., an aminoazobenzene such as 4-aminoazobenzene, an anthraquinone such as 9,10-anthraquinone (9,10-dioxoanthracene), a methine, an azomethine, a triphenylmethane, a styrol, a naphthostyryl, an isoindoline, an indophenol, a nitroarylamino, a naphthoione, a naphthazarine, an oxazine, a coumarin, a quinophthalone, a naphthoquinone, a naphthoquinonimine, a formazan, a benzodifuranone; solvent dyes such as solvent red 24, solvent red 26, solvent red 164, solvent yellow 124 or solvent blue 35; pigments; natural dyes; dyes containing anionic functional groups such as acid dyes, direct, mordant, or a reactive dyes; dyes containing cationic functional groups such as basic dyes; and dyes requiring chemical reaction before application such as vat, azoic, or sulfur dyes.

The solution in which the treatment-material/dye is dissolved may contain any amount of the treatment-material/dye per liter of the solution. For example, in particular embodiments, the solution contains at least about 0.5 gr of the treatment-material/dye per liter of the solution, e.g., about 5 gr or more of the treatment-material/dye, about 10 gr or more of the treatment-material/dye, about 15 gr or more of the treatment-material/dye, or about 20 gr or more of the treatment-material/dye, per liter of the solution. In other certain embodiments, the solution contains 0.05-10%, meaning at least about 0.5 to about 100 gr of the treatment-material/dye per liter of the solution. In specific embodiments, the range is 0.05-9%; 0.05-8%; 0.05-7%; 0.05-6%; 0.05-5%; 0.05-4%; 0.05-3%; 0.05-2%; 0.05-1%; 0.1-10%; 0.15-10%; 0.2-10%; 0.3-10%; 0.4-10%; 0.5-10%; 1-10%; 0.1-9%; 0.2-8%; 0.3-7%; 0.4-6%; 0.5-5%; or 1-5%.

As explained above, in cases the pretreatment step (i) and treating/dyeing step (ii) are combined and carried out simultaneously, the solvent dissolving the treatment-material/dye is, in fact, the swelling agent or the solvent in which the swelling agent is dissolved.

In particular embodiments, the thread dyed according to the process of the invention either comprises, or consists of, a synthetic material, wherein the synthetic material is a polyester, e.g., polyethylene terephthalate (PET), or a polyamide, e.g., nylon or an aramid.

In certain particular such embodiments, the the thread either comprises, or consists of, a polyester, e.g., polyethylene terephthalate (PET), and the swelling agent is acetic acid, acetic anhydride, a ketone such as acetone, diethylketone, benzyl acetone, acetophenone, an ester like ethylheptanoate, 4-tert-Butylcyclohexyl acetate, butyl lactate, ammonia, aniline, aqua regia, benzene, benzyl derivatives such as benzoic acid, benzyl acetate, benzyl alcohol, benzaldehyde, methyl benzoate, ethyl benzoate, propyl benzoate, butyl benzoate, hexyl benzoate, benzyl formate, benzyl propionate, benzyl chloride, benzaldehyde glyceryl acetal, phenethyl derivatives such as, phenethyl alcohol, phenethyl acetate, phenethyl formate, benzyl acetone, phenoxy ethanol, bromine, butyl acetate, formic acid, furfuryl alcohol, hydrochloric acid, hydrofluoric acid, potassium/sodium/ammonium hydroxide, propionic acid, sulfuric acid, isopropyl acetate, chloral hydrate, chlorobenzene, chloroform, chromic acid, cyclohexanone, 1,2-dichloroethane, 1,2-dibromoethane, o-dichlorobenzene, dimethyl formamide, dioxane, an ethoxylated alcohol, ethyl acetate, ethylene chlorohydrin, eugenol, diacetone alcohol, nitrobenzene, phenol, anisole, 1-Phenoxy-2-propanol, Ethylene glycol phenyl ether methacrylate, m-Cresol, methyl salicylate, triethanolamine, or triisopropanolamine. In other particular such embodiments, the thread either comprises, or consisting of, a polyamide, e.g., nylon or an aramid, and the swelling agent is a ketone such as acetone, diethylketone, benzyl acetone, acetophenone, an ester like ethylheptanoate, 4-tert-Butylcyclohexyl acetate, butyl lactate, ammonia, ammonium nitrate, ammonium sulphate, amyl acetate, basic chrome sulphate, benzene, benzyl derivatives such as benzoic acid, benzyl acetate, benzyl alcohol, benzaldehyde, methyl benzoate, ethyl benzoate, propyl benzoate, butyl benzoate, hexyl benzoate, benzyl formate, benzyl propionate, benzyl chloride, benzaldehyde glyceryl acetal, phenethyl derivatives such as, phenethyl alcohol, phenethyl acetate, phenethyl formate, benzyl acetone, phenoxy ethanol, borax, butane gas, butanol, butyric acid, calcium chloride, calcium hydroxide, calcium soap fat, camphour oil, carbon dioxide, carbon disulfide, carbon tetrachloride, caustic soda, citric acid, coal gas, copper sulphate, hydrogen sulfide, potassium carbonate/cyanide/dichromate, sulfuric acid, isopropyl alcohol, cyclohexanone, cyclohexanol, dibutyl phthalate, dioctyl phthalate, dinonyl phthalate, diesel oil, ether, ethyl alcohol, ethylene chloride, ethylene glycol, diacetone alcohol, nitrobenzene, phenol, anisole, 1-Phenoxy-2-propanol, Ethylene glycol phenyl ether methacrylate, m-Cresol, formic acid, ferric chloride, glycerol, glycol, nitric acid, propyl alcohol, methyl alcohol, methyl amine, triethanolamine, trichloroethylene.

According to the process of the present invention, the thread treated in step (ii) is treated, optionally after drying, with a binder or a coating material capable of: fixing to the surface of the thread treatment-molecules left thereon; dyeing; matt-glossing; glittering; and/or add a metallic look, and/or adding functionality such as conductivity, bioactivity, or any other functional smart textile capability. Such a binder or coating materials may be selected from, but not limited to, water based binders such as urethane acrylate, polyvinyl acetate, or polyurethane; solvent based binders such as polyamides, or polyethylene; light curable binders such as urethane acrylate, epoxy, or polyurethane; heat curable binders such as urethane acrylate; or moisture curable binders such as cyano acrylates, polyurethanes, or water repelling coating material like silicone.

While practicing the present invention it has been found that physical properties of the thread treated according to the treating process of the invention, e.g., hardness, flexibility, elongation, volume, and gloss, may be tuned, i.e., altered, as a result of the process, e.g., due to the use of a particular swelling agent. For example, a nylon thread may become softer after the process.

In certain embodiments, the physical properties of the thread treated in step (i) are thus purposely either identical to, or different from, the physical properties of the treated thread obtained as a result of the process. In this respect, it should be noted that one or more of the physical properties of the thread treated in step (i) can also be altered, if so desired, by application of a particular active agent(s) into one of the solutions used in the process, e.g., into the swelling agent or the solution comprising it in step (i), and/or into the treatment solution used in step (ii). For example, a tough thread may become softer and more flexible by application of a softener, a rough thread can be changed to a smoother one by application of a wax, and a dull thread can be changed to a brilliant one. The thread physical properties might be altered also by certain process parameters or combination between solution composition and process parameters, as well as texturizing elements inline of the process.

In another aspect, the present invention relates to a treated/dyed textile thread obtained by the process of the invention as defined in any one of the embodiments defined above.

Unless otherwise indicated, all numbers expressing either molar or weight ratios of the two active agents defined above used in this specification are to be understood as being modified in all instances by the term “about”. Accordingly, unless indicated to the contrary, the numerical parameters set forth in this specification are approximations that may vary by up to plus or minus 10% depending upon the desired properties to be obtained by the present invention.

The invention will now be illustrated by the following non-limiting Examples.

### EXAMPLES

### Example 1

### Dyeing Polyester Fibers according to the Process of the Present Invention

In the present experiment, polyester thread was dyed according to a procedure similar to the process disclosed herein, without using a binder, wherein the swelling agent is a liquid; and steps (i) and (ii) are carried out simultaneously. In particular, dye solution was applied on polyester thread under heating to a temperature of from about 80° C. to about 200° C. for 1 sec, and was then dried at a temperature of about 150° C. to about 200° C. for 10-60 sec.

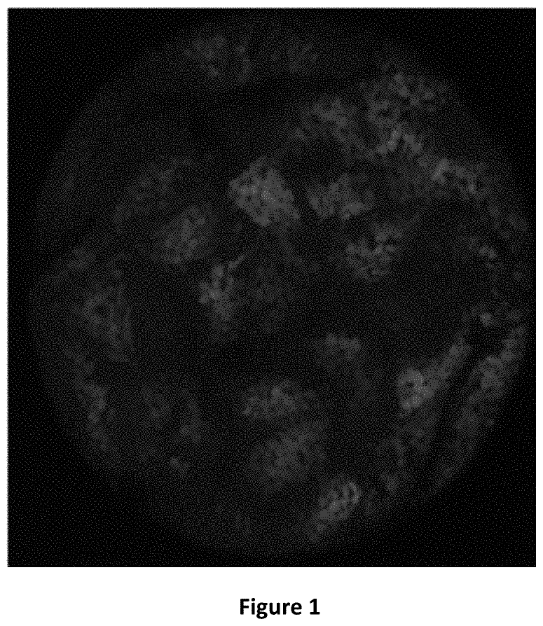

The results of the above dyeing process are shown in FIG. 1, demonstrating dye penetration into the thread fibers. In addition, the treated threads kept most of their original mechanical properties, such as tear strength and % elongation at tearing. The color fastness achieved is described in Table 1 below:

TABLE 1
Fastness properties

| | |
|---|---|
| Color fastness to chlorine bleach (AATCC ASTM | 4-5 |
| TS-001) | |
| Color fastness to artificial saliva (B.82.92-3: | 4-5 |
| 2001) | |
| Color fastness to artificial light - Xenon Arc | 5 |
| fading lamp test (ISO 105-B02: 2014) | |
| Color fastness to domestic & commercial | 4-5 |
| laundering (ISO 105-C06: 2010) | (shade change) |
| Color fastness to dry cleaning (ISO 105-D01: | 4-5 |
| 2010) | |
| Color fastness to perspiration (ISO 105-E04: | 4-5 |
| 2013) | (shade change) |
| Color fastness to water (ISO 105-E01: 2013) | 4-5 |

### Example 2

### Dyeing Polyamide Fibers according to the Process of the Present Invention

In the present experiment, polyamide thread was dyed according to a procedure similar to the process disclosed herein, without using a binder, wherein the swelling agent is a liquid; and the dyeing step follows the pretreatment step. In particular, dye solution was applied on polyamide thread under heating to a temperature of from about 50° C. to about 180° C. for 1 sec, and was then dried at a temperature of from about 100° C. to about 200° C. for 10-120 sec.

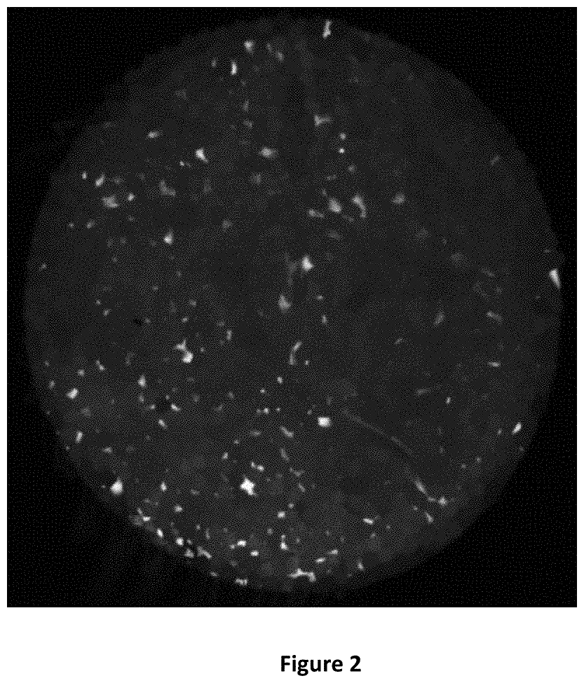

Results: As seen in FIG. 2, all the fibers in the treated thread were dyed with good color fastness and the mechanical properties were kept.

### Example 3

### Treating Dyed Polyester Threads with a Coating Material

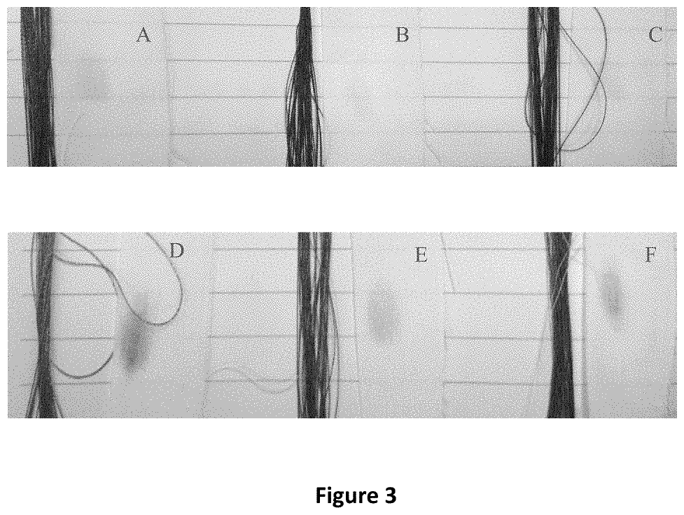

In the present experiment, coating material was applied on polyester threads immediately after dyeing according to the procedure described in Example 1. The coating was dried for about 60 sec. Color fastness for rubbing was tested and the color of the stained fabric was measured. Comparison between different coating materials can be seen in FIGS. 3A-3F showing each colored thread and the corresponding stained fabric on its right. The dE of each of the stained fabrics is presented in Table 2 below.

TABLE 2

| ID | dE* |
|---|---|
| A | 1.94 |
| B | 1.62 |
| C | 1.19 |
| D | 7.88 |
| E | 2.9 |
| F | 5.2 |

Results: the thread treated by the coatings B and C exhibited excellent rub fastness and the mechanical properties were kept.

1.-31. (canceled)

32. A process for rapid treating of a textile thread, said process comprising:
(i) treating said thread with a swelling agent or a solution comprising the same, thereby swelling said thread thus enhancing penetration of a treating agent into amorphous regions of said thread at a temperature higher than the glass transition temperature (T_{g}) or modified T_{g} of said thread;
(ii) treating said thread; and
(iii) optionally treating said thread with a binder or a coating material capable of: (a) fixing treatment-molecules left thereon to the surface of said thread; (b) adding color to the treated thread; (c) adding matt-glossing look to the treated thread; (d) adding glittering; (e) adding a metallic look to the treated thread; and/or (f) adding functionality such as conductivity, bioactivity, friction, or any other functional smart textile capability to the treated thread,
wherein the treated thread is kept at a controlled tension throughout the entire treating process.

33. The process of claim 32, further comprising heating said thread either immediately prior to step (i), or immediately after step (i) and prior to step (ii), or immediately after step (ii) and prior to step (iii), or throughout the entire process, or throughout steps (i) and (ii), or throughout steps (ii) and (iii).

34. The process of claim 32, wherein the thread is heated to a temperature of from about 30° C. to about the melting point of the thread.

35. The process of claim 33, wherein the thread is heated to a temperature of from about 30° C. to about the melting point of the thread.

36. The process of claim 32, wherein the binder, the swelling agent, the treating agent and/or the coating are heated to a temperature of from about 30° C. to about the melting point of the thread.

37. The process of claim 32, wherein said treating step is carried out either by dipping said thread in a solution comprising the treating agent, or by dripping said solution on said thread, or by injecting/dispensing said solution onto said thread, or by ink-jetting said solution onto said thread.

38. The process of claim 32, wherein said treatment-molecules are dissolved in said swelling agent or said solution comprising it, and step (i) and step (ii) are carried out simultaneously.

39. The process of claim 32, further comprising drying said thread either (a) after step (ii) and prior to step (iii), or (b) after step (iii), or (c) after step (ii), prior to step (iii), and after step (iii).

40. The process of claim 32, wherein said thread comprises, or consists of, a natural material, or a synthetic or semisynthetic material.

41. The process of claim 40, wherein said synthetic material is a polyester, e.g., polyethylene terephthalate (PET), or a polyamide, e.g., nylon or an aramid.

42. The process of claim 32, wherein said thread is treated in step (i) with a solution of said swelling agent dissolved in a solvent selected from water, an organic solvent, or a combination thereof.

43. The process of claim 32, wherein said swelling agent is acetic acid, acetic anhydride, a ketone such as acetone, diethylketone, benzyl acetone, acetophenone an ester like ethylheptanoate, 4-tert-butylcyclohexyl acetate, butyl lactate, ammonia, ammonium nitrate, ammonium sulphate, amyl acetate, aniline, aqua regia (a mixture of nitric acid and hydrochloric acid), basic chrome sulphate, benzene, benzyl derivatives such as benzoic acid, benzyl acetate, benzyl alcohol, benzaldehyde, methyl benzoate, ethyl benzoate, propyl benzoate, butyl benzoate, hexyl benzoate, benzyl formate, benzyl propionate, benzyl chloride, benzaldehyde glyceryl acetal, phenethyl derivatives such as, phenethyl alcohol, phenethyl acetate, phenethyl formate, benzyl acetone, phenoxy ethanol, borax (sodium borate, sodium tetraborate, or disodium tetraborate), bromine, butane gas, butanol butyl acetate, butyric acid, calcium chloride, calcium hydroxide, calcium soap fat, camphour oil, carbon dioxide, carbon disulfide, carbon tetrachloride, caustic soda, chloral hydrate, chlorobenzene, chloroform, chromic acid, citric acid, coal gas, copper sulphate, cyclohexanol, cyclohexanone, dibutyl phthalate, dioctyl phthalate, dinonyl phthalate, diesel oil (diesel fuel), 1,2-dibromoethane, 1,2-dichloroethane, dimethyl formamide, dioxane, ether, ethyl alcohol, ethylene chloride, ethylene glycol, an ethoxylated alcohol, ethyl acetate, ethylene chlorohydrin, an eugenol, diacetone alcohol, ferric chloride, formic acid, furfuryl alcohol, glycerol, a glycol, hydrochloric acid, hydrofluoric acid, hydrogen sulfide, isopropyl alcohol, isopropyl acetate, methyl alcohol, methyl amine, nitric acid, potassium carbonate/cyanide/dichromate, potassium/sodium/ammonium hydroxide, propionic acid, propyl alcohol, sulfuric acid, nitrobenzene, phenol, anisole, 1-phenoxy-2-propanol, ethylene glycol phenyl ether methacrylate, m-cresol, methyl salicylate, triethanolamine, trichloroethylene, or triisopropanolamine, or a combination thereof.

44. The process of claim 32, wherein said treatment is dyeing.

45. The process of claim 44, wherein a dye used in the process comprises a disperse dye such as an azobenzene (Azo), e.g., an aminoazobenzene such as 4-aminoazobenzene, an anthraquinone such as 9,10-anthraquinone (9,10-dioxoanthracene), a methine, an azomethine, a triphenylmethane, a styryl, a naphthostyryl, an isoindoline, an indophenol, a nitroarylamino, a naphtholone, a naphthazarine, an oxazine, a coumarin, a quinophthalone, a naphthoquinone, a naphthoquinonimine, a formazan, a benzodifuranone; a solvent dye such as solvent red 24, solvent red 26, solvent red 164, solvent yellow 124 or solvent blue 35; a pigment; a natural dye;
a dye containing anionic functional groups such as an acid dye, direct, mordant, or a reactive dye; a dye containing cationic functional groups such as a basic dye; or a dye requiring chemical reaction before application such as vat, azoic, or a sulfur dye; or a combination thereof.

46. The process of claim 44, wherein the solution contains at least about 0.5 gr of a dye per liter of said solution.

47. The process of claim 40, wherein:
(i) said synthetic material is a polyester, and said swelling agent is acetic acid, acetic anhydride, a ketone such as acetone, diethylketone, benzyl acetone, acetophenone, an ester like ethylheptanoate, 4-tert-butylcyclohexyl acetate, butyl lactate, ammonia, aniline, aqua regia, benzene, benzyl derivatives such as benzoic acid, benzyl acetate, benzyl alcohol, benzaldehyde, methyl benzoate, ethyl benzoate, propyl benzoate, butyl benzoate, hexyl benzoate, benzyl formate, benzyl propionate, benzyl chloride, benzaldehyde glyceryl acetal, phenethyl derivatives such as, phenethyl alcohol, phenethyl acetate, phenethyl formate, benzyl acetone, phenoxy ethanol, bromine, butyl acetate, formic acid, furfuryl alcohol, hydrochloric acid, hydrofluoric acid, potassium/sodium/ammonium hydroxide, propionic acid, sulfuric acid, isopropyl acetate, chloral hydrate, chlorobenzene, chloroform, chromic acid, cyclohexanone, 1,2-dichloroethane, 1,2-dibromoethane, o-dichlorobenzene, dimethyl formamide, dioxane, an ethoxylated alcohol, ethyl acetate, ethylene chlorohydrin, eugenol, diacetone alcohol, nitrobenzene, phenol, anisole, 1-phenoxy-2-propanol, ethylene glycol phenyl ether methacrylate, m-cresol, methyl salicylate, triethanolamine, or triisopropanolamine, or a combination thereof; or (ii) said synthetic material is a polyamide such as nylon, and said swelling agent is a ketone such as acetone, diethylketone, benzyl acetone, acetophenone, an ester like ethylheptanoate, 4-tert-butylcyclohexyl acetate, butyl lactate, ammonia, ammonium nitrate, ammonium sulphate, amyl acetate, basic chrome sulphate, benzene, benzyl derivatives such as benzoic acid, benzyl acetate, benzyl alcohol, benzaldehyde, methyl benzoate, ethyl benzoate, propyl benzoate, butyl benzoate, hexyl benzoate, benzyl formate, benzyl propionate, benzyl chloride, benzaldehyde glyceryl acetal, phenethyl derivatives such as, phenethyl alcohol, phenethyl acetate, phenethyl formate, benzyl acetone, phenoxy ethanol, borax, butane gas, butanol, butyric acid, phenthyl alcohol, calcium chloride, calcium hydroxide, calcium soap fat, camphour oil, carbon dioxide, carbon disulfide, carbon tetrachloride, caustic soda, citric acid, coal gas, copper sulphate, hydrogen sulfide, potassium carbonate/cyanide/dichromate, sulfuric acid, isopropyl alcohol, cyclohexanone, cyclohexanol, dibutyl phthalate, dioctyl phthalate, dinonyl phthalate, diesel oil, ether, ethyl alcohol, ethylene chloride, ethylene glycol, phenol, diacetone alcohol, nitrobenzene, phenol, anisole, 1-phenoxy-2-propanol, ethylene glycol phenyl ether methacrylate, m-cresol, formic acid, ferric chloride, glycerol, glycol, nitric acid, propyl alcohol, methyl alcohol, methyl amine, triethanolamine, or trichloroethylene, or a combination thereof.

48. The process of claim 32, wherein said binder is selected from water-based binder, a solvent based binder, a light curable binder, a heat curable binder, a moisture curable binder, or a combination thereof.

49. The method of claim 48, wherein said water based binder is urethane acrylate, polyvinyl acetate, or polyurethane; said solvent based binder is a polyamide, or polyethylene;
said light curable binder is urethane acrylate, epoxy, or polyurethane; said heat curable binder is urethane acrylate; or said moisture curable binder is a cyano acrylate, polyurethane, or water repelling coating like silicone.

50. The process of claim 32, wherein the physical properties of the thread treated in step (i) are either purposely identical to those of the treated thread obtained as a result of said process, or purposely different from those of the treated thread obtained as a result of said process.

51. A treated textile thread obtained by the process of claim 32.

52. A method for producing a textile thread by the process of claim 32.
